(19) United States
(12) Patent Application Publication
(10) Pub. No.: US 2026/0247251 A1
(43) Pub. Date: Aug. 20, 2026

(54) METHODS AND APPARATUSES OF A FAILURE HANDLING MECHANISM FOR A CONDITIONAL HANDOVER (CHO) PROCEDURE

(71) Applicant: Lenovo (Beijing) Limited, Beijing (CN)

(72) Inventors: Lianhai Wu, Beijing (CN); Le Yan, Shanghai (CN); Congchi Zhang, Shanghai (CN); Mingzeng Dai, Shanghai (CN)

(73) Assignee: Lenovo (Beijing) Limited, Beijing (CN)

(21) Appl. No.: 18/992,683

(22) PCT Filed: Jul. 20, 2022
(86) PCT No.: PCT/CN2022/106743

§ 371 Date: Jan. 9, 2025

(51) Int. Cl. H04W 36/36

(52) U.S. Cl. CPC H04W 36/362

(57) ABSTRACT

Embodiments of the present application relate to methods and apparatuses (900) of a failure handling mechanism for conditional handover (CHO). According to an embodiment of the present application, a user equipment (UE 101) includes a transceiver (902) and a processor (906) coupled to the transceiver (902); and the processor (906) is configured to: receive a conditional handover (CHO) configuration associated with a target master cell group (MCG) and a target secondary cell group (SCG) via the transceiver (902), wherein the CHO configuration includes a CHO execution condition for the target MCG, and wherein the target SCG is same as or different from a source SCG of the UE (201); evaluate the CHO execution condition for the target MCG (202); and perform a CHO procedure to the target MCG, in response to fulfillment of the CHO execution condition for the target MCG (203).

### TECHNICAL FIELD

Embodiments of the present application generally relate to methods and apparatuses of a failure handling mechanism for a conditional handover (CHO) procedure.

### BACKGROUND

A CHO is defined as a handover that is executed by a user equipment (UE) when one or more handover execution conditions are met. The UE starts evaluating the one or more handover execution conditions upon receiving the one or more CHO configurations and one or more CHO execution conditions, and stops evaluating the one or more CHO execution conditions during the CHO execution once the one or more CHO execution conditions are met.

Next generation radio access network (NG-RAN) supports a multi-radio dual connectivity (MR-DC) scenario. In a MR-DC scenario, a UE with multiple transceivers may be configured to utilize resources provided by two different nodes connected via non-ideal backhauls. Wherein one node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, a Xn interface as specified in 3rd Generation Partnership Project (3GPP) standard documents), and at least the MN is connected to the core network. Currently, details regarding a failure handling mechanism for a CHO procedure in an MR-DC scenario have not been discussed yet.

### SUMMARY

Some embodiments of the present application provide a user equipment (UE). The UE includes a transceiver and a processor coupled to the transceiver; and the processor is configured to: receive a conditional handover (CHO) configuration associated with a target master cell group (MCG) and a target secondary cell group (SCG) via the transceiver, wherein the CHO configuration includes a CHO execution condition for the target MCG, and wherein the target SCG is same as or different from a source SCG of the UE; evaluate the CHO execution condition for the target MCG; and perform a CHO procedure to the target MCG, in response to fulfillment of the CHO execution condition for the target MCG.

In some embodiments, in response to the UE connected to a source MCG and in response to an occurrence of a failure on the source SCG, the processor of the UE is configured to: initiate a first SCG failure information procedure, to report first information associated with the failure on the source SCG to the source MCG; and suspend a link between the source SCG and the UE.

In some embodiments, in response to the target SCG being the same as the source SCG, the processor of the UE is configured to perform at least one of: performing a random access (RA) procedure to the target MCG; prohibiting performing an RA procedure to the target SCG; or transmitting second information associated with a failure on the source SCG via the transceiver to the target MCG, in response to successfully completing an RA procedure to the target MCG.

In some embodiments, the second information is included in a radio resource control (RRC) reconfiguration complete message.

In some embodiments, the processor of the UE is configured to initiate a second SCG failure information procedure, wherein the second information is included in a SCG failure information message, and wherein the SCG failure information message is transmitted to the target MCG.

In some embodiments, the second information includes at least one of: a first indication indicating that the failure occurs on the source SCG; a second indication indicating that the failure occurs on the source SCG before performing the CHO procedure to the target MCG; or a third indication indicating that the first information has been transmitted to the source MCG.

In some embodiments, the CHO configuration includes an RRC configuration for the target SCG, and wherein the processor of the UE is configured to perform at least one of: applying the RRC configuration for the target SCG in response to performing the CHO procedure; or continuing to suspend the link between the source SCG and the UE.

In some embodiments, the processor of the UE is configured to consider the CHO execution condition for the target MCG as fulfilled while the UE is suspending the link between the source SCG and the UE.

In some embodiments, the CHO configuration includes an RRC configuration for the target SCG, and wherein the processor of the UE is configured to: release the RRC configuration for the target SCG; and transmit an RRC message including a fourth indication via the transceiver to the target MCG, wherein the fourth indication indicates at least one of: the RRC configuration for the target SCG is not applied; or the occurrence of the failure on the target SCG.

In some embodiments, in response to the target SCG being the same as or different from the source SCG, the CHO configuration includes an RRC configuration for the target MCG and an RRC configuration for the target SCG, wherein the RRC configuration for the target SCG is updated based on an RRC configuration for the source SCG.

In some embodiments, in response to a change of a primary secondary cell group cell (PSCell) of the source SCG or an update of an RRC configuration for the source SCG, the processor of the UE is configured to perform at least one of: continuing the CHO procedure to the target MCG; prohibiting applying the RRC configuration for the target SCG; prohibiting performing a random access (RA) procedure to the target SCG; or transmitting third information via the transceiver to the target MCG, wherein the third information is associated with the change of the PSCell of the source SCG or the update of the RRC configuration for the source SCG.

In some embodiments, the third information is included in a radio resource control (RRC) reconfiguration complete message or a SCG failure information message.

In some embodiments, in response to a change of a primary secondary cell group cell (PSCell) of the source SCG or an update of an RRC configuration for the source SCG, the processor of the UE is configured to: perform the CHO procedure to the target MCG and the target SCG; apply updated RRC configuration for the target SCG after the change of the PSCell of the source SCG or the update of the RRC configuration for the source SCG; and transmit fourth information via the transceiver to the target MCG, wherein the fourth information is associated with the change of the PSCell of the source SCG or the update of the RRC configuration for the source SCG.

In some embodiments, the processor of the UE is configured to store the RRC configuration for the source SCG in response to reception of the CHO configuration or in response to the change of the PSCell of the source SCG or in response to the update of the RRC configuration for the source SCG.

In some embodiments, in response to a change of a primary secondary cell group cell (PSCell) of the source SCG or an update of an RRC configuration for the source SCG, the processor of the UE is configured to: continue to perform the CHO procedure to the target MCG; apply the RRC configuration for the target SCG during performing the CHO procedure to the target MCG; and perform an RA procedure to the target SCG.

Some embodiments of the present application also provide a target master node (MN). The target MN includes a transceiver and a processor coupled to the transceiver; and the processor is configured to: receive a handover request message via the transceiver from a source MN; transmit a handover request acknowledge message via the transceiver to the source MN, wherein the handover request acknowledge message includes a conditional handover (CHO) configuration associated with a target secondary cell group (SCG) of a user equipment (UE), and wherein the target SCG is same as or different from a source SCG of the UE; and receive failure related information via the transceiver from the UE.

In some embodiments, the failure related information is received after the UE successfully completing an RA procedure to a target MCG.

In some embodiments, the failure related information is included in a radio resource control (RRC) reconfiguration complete message or a SCG failure information message.

In some embodiments, in response to the target SCG being the same as the source SCG, the failure related information is associated with an occurrence of a failure on the source SCG.

In some embodiments, in response to the target SCG being the same as the source SCG, the failure related information includes at least one of: a first indication indicating that a failure occurs on the source SCG; a second indication indicating that the failure occurs on the source SCG before performing the CHO procedure to the target MCG; or a third indication indicating that first information associated with the failure on the target SCG has been transmitted to the source MCG.

In some embodiments, the CHO configuration includes an RRC configuration for the target SCG, wherein the processor of the target MN is configured to receive an RRC message including a fourth indication via the transceiver from the UE, and wherein the fourth indication indicates at least one of: the RRC configuration for the target SCG is not applied; or an occurrence of a failure on the target SCG.

In some embodiments, in response to the target SCG being the same as or different from the source SCG, the CHO configuration includes an RRC configuration for the target MCG and an RRC configuration for the target SCG, wherein the RRC configuration for the target SCG is updated based on an RRC configuration for the source SCG.

In some embodiments, the failure related information is associated with a change of a primary secondary cell group cell (PSCell) of the source SCG or an update of an RRC configuration for the source SCG.

Some embodiments of the present application also provide a source master node (MN). The source MN includes a transceiver and a processor coupled to the transceiver; and the processor is configured to: transmit a handover request message via the transceiver to a target MN; and receive a handover request acknowledge message via the transceiver from the target MN, wherein the handover request acknowledge message includes a conditional handover (CHO) configuration associated with a target master cell group (MCG) and a target secondary cell group (SCG) of a user equipment (UE).

In some embodiments, the processor of the source MN is further configured to receive an indication via the transceiver from a source SN, and wherein the indication indicates at least one of: a change of a primary secondary cell group cell (PSCell) of the source SCG; or an update of an RRC configuration for the source SCG.

Some embodiments of the present application also provide a source secondary node (SN). The source SN includes a transceiver and a processor coupled to the transceiver; and the processor is configured to: transmit a configuration associated with a change of a primary secondary cell group cell (PSCell) of a source SCG of a user equipment (UE) or an update of an RRC configuration for the source SCG via the transceiver to the UE; and transmit an indication via the transceiver to a source MN, wherein the indication indicates at least one of: a change of a primary secondary cell group cell (PSCell) of the source SCG; or an update of an RRC configuration for the source SCG.

Some embodiments of the present application provide a method performed by a UE. The method includes: receiving a conditional handover (CHO) configuration associated with a target master cell group (MCG) and a target secondary cell group (SCG), wherein the CHO configuration includes a CHO execution condition for the target MCG, and wherein the target SCG is same as or different from a source SCG of the UE; evaluating the CHO execution condition for the target MCG; and performing a CHO procedure to the target MCG, in response to fulfillment of the CHO execution condition for the target MCG.

Some embodiments of the present application provide a method performed by a target MN. The method includes: receiving a handover request message from a source MN; transmitting a handover request acknowledge message to the source MN, wherein the handover request acknowledge message includes a conditional handover (CHO) configuration associated with a target secondary cell group (SCG) of a user equipment (UE), and wherein the target SCG is same as or different from a source SCG of the UE; and receiving failure related information from the UE.

Some embodiments of the present application provide a method performed by a source MN. The method includes: transmitting a handover request message to a target MN; and receiving a handover request acknowledge message from the target MN, wherein the handover request acknowledge message includes a conditional handover (CHO) configuration associated with a target master cell group (MCG) and a target secondary cell group (SCG) of a user equipment (UE).

Some embodiments of the present application provide a method performed by a source SN. The method includes: transmitting, to a user equipment (UE), a configuration associated with a change of a primary secondary cell group cell (PSCell) of a source SCG of the UE or an update of an RRC configuration for the source SCG; and transmitting an indication to a source MN, wherein the indication indicates at least one of: a change of a primary secondary cell group cell (PSCell) of the source SCG; or an update of an RRC configuration for the source SCG.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (a source MN, a target MN, a source SN, or a target SN).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIGS. 2-5 illustrate exemplary procedures of failure handling mechanisms for CHO in accordance with some embodiments of the present application.

FIGS. 6-8 illustrate flowcharts of exemplary procedures of wireless communications in accordance with some embodiments of the present application.

FIG. 9 illustrates a block diagram of an exemplary apparatus in accordance with some embodiments of the present disclosure.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

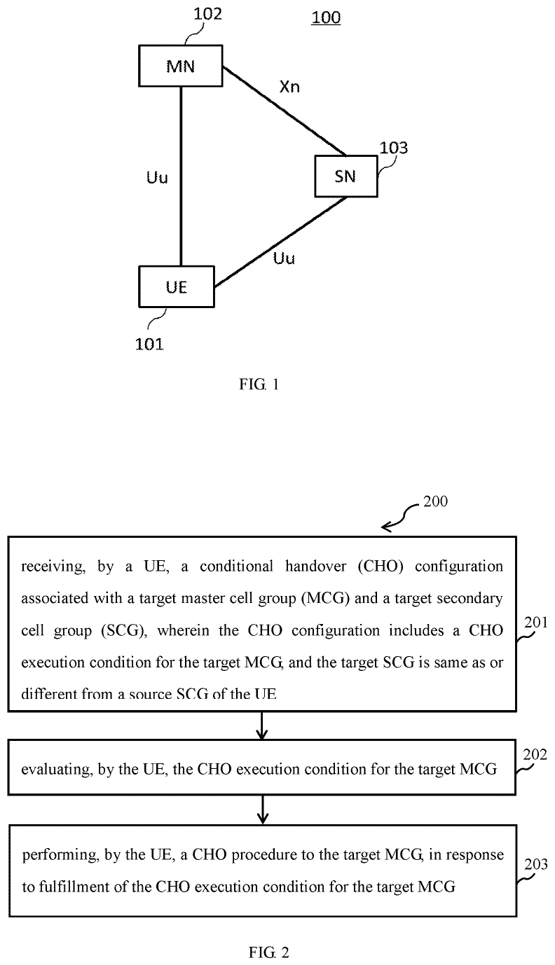

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents for NR-NR DC or NGEN-DC or NE-DC, or X2 interface as specified in 3GPP standard documents for EN-DC. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In general, a CHO is executed by a UE when one or more handover execution conditions are met. A UE starts evaluating the execution condition(s) upon receiving the CHO configuration, and stops evaluating the execution condition during the CHO execution once the execution condition(s) is met. A CHO configuration contains the configuration for CHO candidate cell(s) generated by the candidate BS(s) and execution condition(s) generated by the source BS.

As in an intra-NR RAN handover, or in intra-NR radio access network (RAN) CHO, the preparation and execution phase of the CHO procedure is performed without involvement of the 5G Core Network (5GC); i.e., preparation messages are directly exchanged between BSs. The release of the resources at the source BS during the conditional handover completion phase is triggered by the target BS, wherein neither the access and mobility management function (AMF) nor the user plane function UPF changes.

Currently, an inter-MN handover with or without MN initiated SN change is used to transfer UE context data from a source MN to a target MN while the UE context at the SN is kept or moved to another SN. During an Inter-MN handover, the target MN decides whether to keep or change the SN (or release the SN). Only intra radio access technology (intra-RAT) Inter-MN handover with or without SN change is supported.

In some cases, an M-NG-RAN node initiates the procedure by sending the S-NODE ADDITION REQUEST message to the S-NG-RAN node. If the CHO Information SN Addition IE is included in the S-NODE ADDITION REQUEST message, the S-NG-RAN node shall consider that the S-NG-RAN node Addition Preparation procedure has been triggered as part of a conditional handover. It may use the Source M-NG-RAN node ID IE and the Source M-NG-RAN node UE XnAP ID IE to identify other active S-NG-RAN node Addition Preparations related to this UE. If the Estimated Arrival Probability IE is contained in the CHO Information SN Addition IE included in the S-NODE ADDITION REQUEST message, the S-NG-RAN node may use the information to allocate necessary resources for the UE.

In some other cases, an M-NG-RAN node initiates the procedure by sending the S-NODE MODIFICATION REQUEST message to the S-NG-RAN node. If the CHO Information SN Modification IE is included in the S-NODE MODIFICATION REQUEST message, the S-NG-RAN node shall consider that the M-NG-RAN node initiated S-NG-RAN node Modification Preparation procedure has been triggered as part of a conditional handover. If the Estimated Arrival Probability IE is contained in the CHO Information SN Modification IE included in the S-NODE MODIFICATION REQUEST message, the S-NG-RAN node may use the information to allocate necessary resources for the UE.

3GPP standard document TS 38.331 introduces some events for a CHO procedure, e.g., CondEvent A3, CondEvent A4, CondEvent A5, CondEvent B1, and CondEvent B2, respectively.

In general, a purpose of a SCG failure information procedure is to inform E-UTRAN or NR MN about a SCG failure the UE has experienced. A SCG failure type includes a SCG radio link failure, a failure of SCG reconfiguration with sync, a SCG configuration failure for an RRC message on signalling radio bearer (SRB) 3, a SCG integrity check failure, and a consistent uplink LBT failure on a PSCell for operation with shared spectrum channel access. A SCG failure type, measurement result(s) in MCG, and/or measurement result(s) in SCG can be included in a SCG failure information message. After the network receives the SCG failure information message, it can trigger the UE to perform a SN release or modification or change procedure. The following information can also be included in the SCG failure information message in case of a SCG failure: previous PSCell ID (i.e., PCI); failed PSCell ID (i.e., PCI); time SCG failure and/or RA-Information.

Currently, there is a scenario of a CHO procedure including different SCGs in which a UE performs the CHO procedure from a source PCell with a source SCG to a target PCell with a target SCG, or another scenario of a CHO procedure from single-connectivity to an MR-DC connection in which a UE performs the CHO procedure from a source cell to a target PCell with a target SCG. In above two scenarios, it is possible that a failure occurs before or after CHO execution condition(s) for a PCell is met. Embodiments of the present disclosure aim to solve such issue in the abovementioned scenarios. More details regarding the embodiments of the present application will be illustrated in the following text in combination with the appended drawings.

FIG. 2 illustrates an exemplary procedure of performing a CHO procedure to in accordance with some embodiments of the present application. The exemplary procedure 200 in the embodiments of FIG. 2 may be performed by a UE, e.g., UE 101 as shown in FIG. 1. Although described with respect to a UE, it should be understood that other devices may be configured to perform a method similar to that of FIG. 2.

In the exemplary procedure 200 as shown in FIG. 2, in operation 201, a UE may receive a CHO configuration associated with a target MCG and a target SCG. The CHO configuration may include a CHO execution condition for the target MCG. The target SCG may be the same as or different from a source SCG of the UE. In operation 202, the UE may evaluate the CHO execution condition for the target MCG. In operation 203, the UE may perform a CHO procedure to the target MCG, in response to fulfillment of the CHO execution condition for the target MCG.

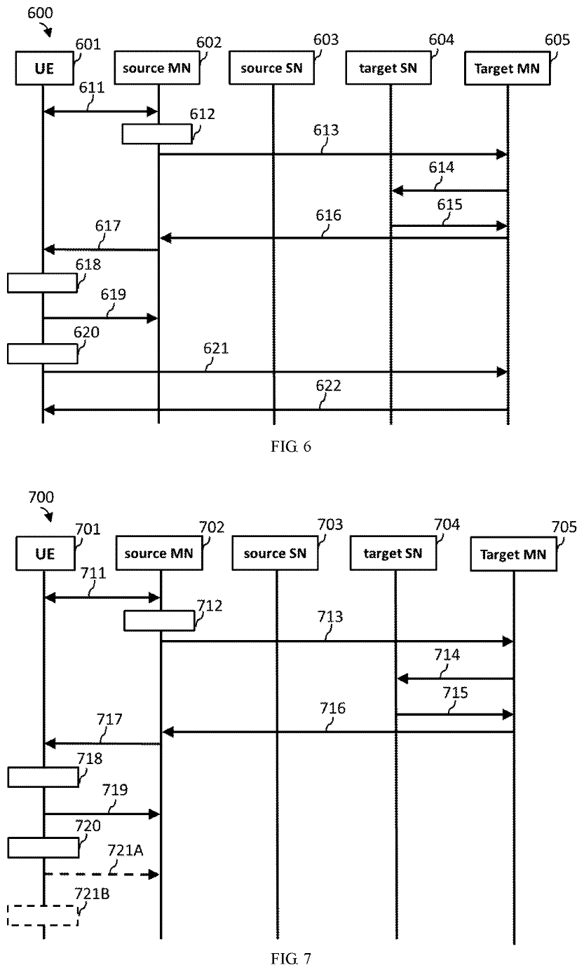

In some embodiments, in response to the UE connected to a source MCG and in response to an occurrence of a failure on the source SCG, the UE may initiate a SCG failure information procedure (e.g., in operation 619 as shown in FIG. 6), to report information associated with the failure on the source SCG (denoted as information #1 for simplicity) to the source MCG, and may suspend a link between the source SCG and the UE. In an embodiment, the UE may consider the CHO execution condition for the target MCG as fulfilled while the UE is suspending the link between the source SCG and the UE.

In some embodiments, in case that the target SCG is the same as the source SCG, the UE may perform at least one of:
(1) performing an RA procedure to the target MCG;
(2) prohibiting performing an RA procedure to the target SCG; or
(3) transmitting information associated with a failure on the source SCG (denoted as information #2 for simplicity) to the target MCG, in response to successfully completing an RA procedure to the target MCG. In an embodiment, information #2 is included in an RRC reconfiguration complete message (e.g., in Option 1 of operation 621 as shown in FIG. 6).

In some embodiments, in case that the target SCG is the same as the source SCG, the UE may initiate another SCG failure information procedure (e.g., in Option 2 of operation 621 as shown in FIG. 6). Information #2 may be included in a SCG failure information message. The SCG failure information message may be transmitted to the target MCG.

In some embodiments, information #2 may include at least one of:
(1) an indication indicating that the failure occurs on the source SCG;
(2) an indication indicating that the failure occurs on the source SCG before performing the CHO procedure to the target MCG; or
(3) an indication indicating that information #1 has been transmitted to the source MCG.

In some embodiments, in case that the target SCG is the same as the source SCG, the CHO configuration includes an RRC configuration for the target SCG, and the UE may perform at least one of:
(1) applying the RRC configuration for the target SCG in response to performing the CHO procedure; or
(2) continuing to suspend the link between the source SCG and the UE. In an embodiment, the UE may consider the CHO execution condition for the target MCG as fulfilled while the UE is suspending the link between the source SCG and the UE. A specific example is described in Option 1 and Option 2 of operation 621 in the embodiments of FIG. 6 as below.

In some embodiments, in case that the target SCG is the same as the source SCG, the CHO configuration includes an RRC configuration for the target SCG, and the UE may release the RRC configuration for the target SCG and transmit an RRC message including another indication to the target MCG. The another indication may indicate at least one of: the RRC configuration for the target SCG is not applied; or the occurrence of the failure on the target SCG. A specific example is described in Option 3 of operation 621 in the embodiments of FIG. 6 as below.

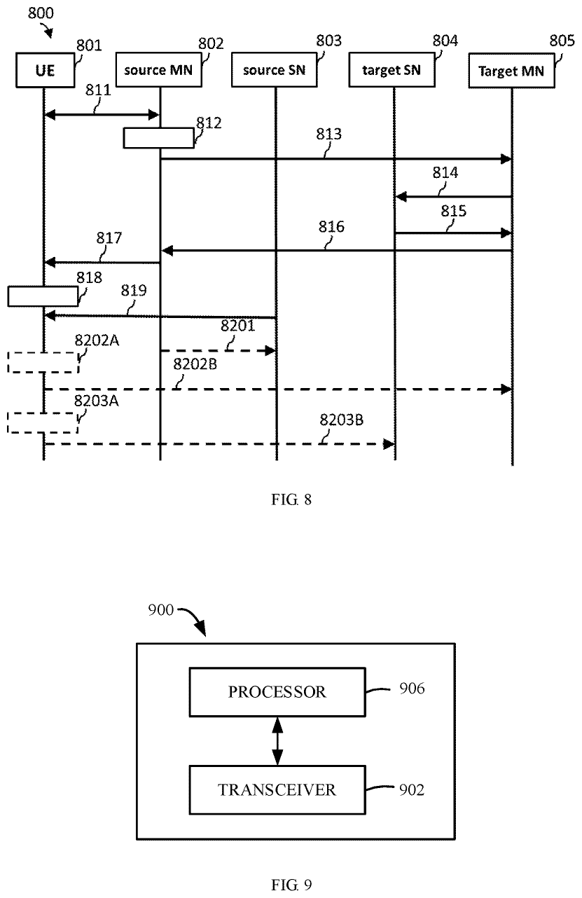

In some embodiments, in case that the target SCG is the same as or different from the source SCG, the CHO configuration includes an RRC configuration for the target MCG and an RRC configuration for the target SCG. The RRC configuration for the target SCG may be updated based on an RRC configuration for the source SCG. For instance, the RRC configuration for the target SCG may be named as “RRC delta configuration” or “RRC difference configuration” for the target SCG or the like. A specific example is described in the embodiments of FIG. 8 as below.

In some embodiments, in response to a change of a PSCell of the source SCG or an update of an RRC configuration for the source SCG, the UE may perform at least one of:
(1) continuing the CHO procedure to the target MCG;
(2) prohibiting applying the RRC configuration for the target SCG;
(3) prohibiting performing an RA procedure to the target SCG; or
(4) transmitting information (denoted as information #3 for simplicity), which is associated with the change of the PSCell of the source SCG or the update of the RRC configuration for the source SCG, to the target MCG (e.g., in operation 8202B of Option (2) as shown in FIG. 8). For instance, information #3 may be included in an RRC reconfiguration complete message or a SCG failure information message.

In some embodiments, in response to a change of a PSCell of the source SCG or an update of an RRC configuration for the source SCG, the UE may: perform the CHO procedure to the target MCG and the target SCG; apply updated RRC configuration for the target SCG after the change of the PSCell of the source SCG or the update of the RRC configuration for the source SCG; and transmit information (denoted as information #4 for simplicity) to the target MCG (e.g., in operation 8202B of Option (3) as shown in FIG. 8). Information #4 may be associated with “the change of the PSCell of the source SCG” or “the update of the RRC configuration for the source SCG”. For example, the updated RRC configuration for the target SCG is updated based on an RRC configuration for the source SCG and an RRC delta configuration for the target SCG.

In some embodiments, the UE may store the RRC configuration for the source SCG in response to reception of the CHO configuration or in response to the change of the PSCell of the source SCG or in response to the update of the RRC configuration for the source SCG.

In some embodiments, in response to a change of a PSCell of the source SCG or an update of an RRC configuration for the source SCG, the UE may: continue to perform the CHO procedure to the target MCG; apply the RRC configuration for the target SCG during performing the CHO procedure to the target MCG; and perform an RA procedure to the target SCG. A specific example is described in the embodiments of FIG. 8 as below.

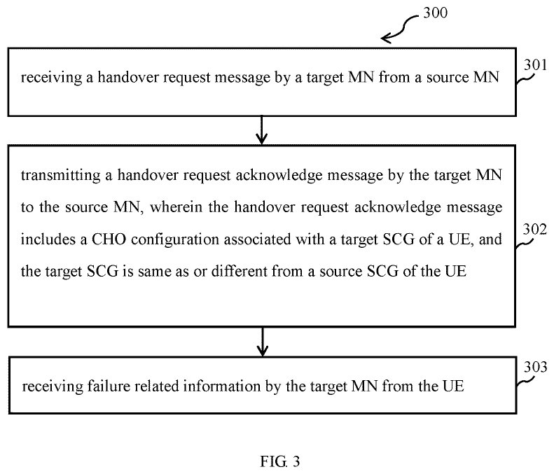

FIG. 3 illustrates an exemplary procedure of receiving failure related information in accordance with some embodiments of the present application. The exemplary procedure 300 in the embodiments of FIG. 3 may be performed by a target MN, e.g., MN 102 as shown in FIG. 1. Although described with respect to a target MN, it should be understood that other devices may be configured to perform a method similar to that of FIG. 3.

In the exemplary procedure 300 as shown in FIG. 3, in operation 301, a target MN may receive a handover request message from a source MN (e.g., SN 103 as shown in FIG. 1). In operation 302, the target MN may transmit a handover request acknowledge message to the source MN. The handover request acknowledge message may include a CHO configuration associated with a target SCG of a UE (e.g., UE 101 as shown in FIG. 1). The target SCG may be the same as or different from a source SCG of the UE. In operation 302, the target MN may receive failure related information from the UE.

In some embodiments, the failure related information is received after the UE successfully completing an RA procedure to a target MCG.

In some embodiments, the failure related information is included in an RRC reconfiguration complete message or a SCG failure information message.

In some embodiments, in case that the target SCG is the same as the source SCG, the failure related information (e.g., information #2) is associated with an occurrence of a failure on the source SCG.

In some embodiments, in case that the target SCG is the same as the source SCG, the failure related information (e.g., information #2) includes at least one of:
(1) an indication indicating that a failure occurs on the target SCG;
(2) an indication indicating that the failure occurs on the source SCG before performing the CHO procedure to the target MCG; or
(3) an indication indicating that first information associated with the failure on the target SCG has been transmitted to the source MCG.

In some embodiments, the CHO configuration includes an RRC configuration for the target SCG, and the target MN may receive an RRC message including another indication from the UE. The another indication may indicate at least one of: the RRC configuration for the target SCG is not applied; or an occurrence of a failure on the target SCG. A specific example is described in Option 3 of operation 621 in the embodiments of FIG. 6 as below.

In some embodiments, in case that the target SCG is the same as or different from the source SCG, the CHO configuration includes an RRC configuration for the target MCG and an RRC configuration for the target SCG. The RRC configuration for the target SCG is updated based on an RRC configuration for the source SCG. The RRC configuration for the target SCG may be named as “RRC delta configuration” or “RRC difference configuration” for the target SCG or the like. A specific example is described in the embodiments of FIG. 8 as below.

In some embodiments, the failure related information is associated with a change of a PSCell of the source SCG or an update of an RRC configuration for the source SCG, e.g., in Option (2) or Option (3) in the embodiments of FIG. 8.

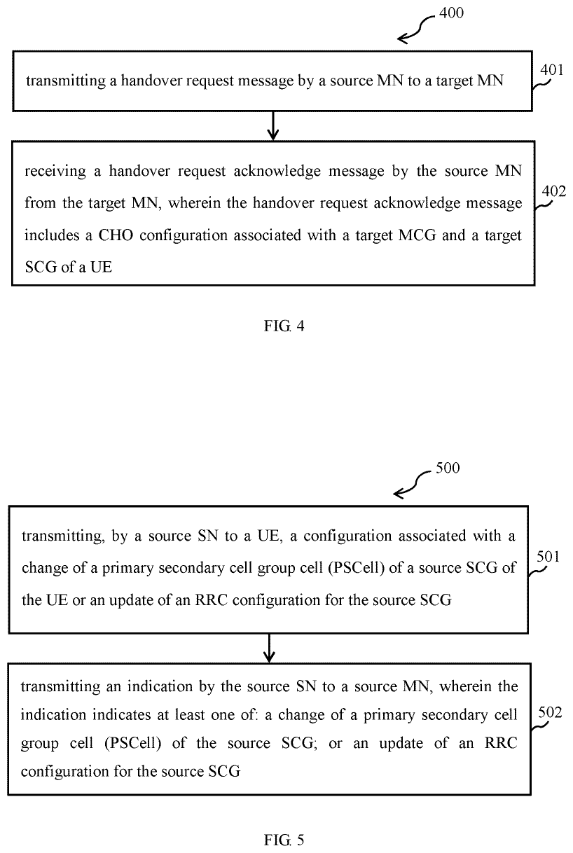

FIG. 4 illustrates an exemplary procedure of transmitting a handover request message in accordance with some embodiments of the present application. The exemplary procedure 400 in the embodiments of FIG. 4 may be performed by a source MN, e.g., MN 802 as shown in FIG. 8. Although described with respect to a source SN, it should be understood that other devices may be configured to perform a method similar to that of FIG. 4.

In the exemplary procedure 400 as shown in FIG. 4, in operation 401, a source MN may transmit a handover request message to a target MN (e.g. target MN 805 as shown in FIG. 8). In operation 402, the source MN may receive a handover request acknowledge message from the target MN. The handover request acknowledge message includes a CHO configuration associated with a target MCG and a target SCG of a UE (e.g., UE 801 as shown in FIG. 8). The target SCG may be same as or different from a source SCG of the UE.

In some embodiments, the source MN may receive an indication from a source SN. The indication may indicate at least one of: a change of a primary secondary cell group cell (PSCell) of the source SCG; or an update of an RRC configuration for the source SCG. A specific example is described in Option (1) in the embodiments of FIG. 8 as below.

FIG. 5 illustrates an exemplary procedure of transmitting an indication in accordance with some embodiments of the present application. The exemplary procedure 500 in the embodiments of FIG. 5 may be performed by a source SN, e.g., SN 803 as shown in FIG. 8. Although described with respect to a source SN, it should be understood that other devices may be configured to perform a method similar to that of FIG. 5.

In the exemplary procedure 500 as shown in FIG. 5, in operation 501, a source SN may transmit a configuration associated with a change of a PSCell of a source SCG of a UE (e.g., UE 801 as shown in FIG. 8) or an update of an RRC configuration for the source SCG to the UE. In operation 502, the source SN may transmit an indication to a source MN (e.g., source MN 802 as shown in FIG. 8). The indication may indicate at least one of: a change of a PSCell of the source SCG; or an update of an RRC configuration for the source SCG. A specific example is described in Option (1) in the embodiments of FIG. 8 as below.

Details described in all other embodiments of the present application are applicable for the embodiments shown in any of FIGS. 2-5. It should be appreciated by persons skilled in the art that the sequence of the operations in any of exemplary procedures 200-500 in FIGS. 2-5 may be changed and some of the operations in any of exemplary procedures 200-500 in FIGS. 2-5 may be eliminated or modified, without departing from the spirit and scope of the disclosure.

The following texts describe specific embodiments as shown and illustrated in FIGS. 2-5, in which a UE and network nodes (e.g., a source MN, a target MN, a source SN, and/or a target SN) perform following operations.

Currently, there may be a case that a CHO procedure includes a target SCG which is the same as a source SCG, and CHO execution condition(s) for a PCell is met while a UE suspends a link between a source SCG and the UE due to, e.g., an RLF on the source SCG. For example, in one case, a UE may initiate a SCG failure information procedure and suspend a link between a source SCG and the UE, e.g., when detecting an RLF on a SCG. It is possible that CHO execution condition(s) is met while the UE still suspends SCG link. In another case, a SCG is deactivated, and an RLF or a beam failure may be detected. It is possible that CHO execution condition(s) is met while the RLF or the beam failure is detected for the deactivated SCG. Thus, there is a need to solve an issue of how to handle a MCG and a SCG included in CHO configuration(s) when CHO execution condition(s) is met while a UE is still suspending a link between a source SCG and the UE.

The embodiments of FIGS. 6 and 7 may solve the abovementioned issue. For example, in the embodiments of FIG. 6, a UE continues to perform the CHO procedure in the above cases. In some embodiments of FIG. 7, a UE will not perform a CHO procedure even CHO execution condition(s) is met in the above cases. In some other embodiments of FIG. 7, a UE will stop evaluating CHO execution condition(s) when the UE suspends a link between a source SCG and the UE in the above cases.

FIG. 6 illustrates a flowchart of an exemplary procedure 600 of wireless communications in accordance with some embodiments of the present application. Operations 611 to 622 may be performed in the exemplary procedure 600. In a CHO procedure described in the embodiments of FIG. 6, a target SCG of a UE is the same as a source SCG of the UE.

In operation 611, UE 601 in an RRC connected state accesses its serving BS, i.e., source MN 602. For instance, DC (Dual Connectivity) may be configured for UE 601. UE 601 may report measurement result(s) to source MN 602.

In operation 612, based on the measurement result(s), source MN 602 may determine to switch UE 601 to target MN 605 via a CHO procedure.

In operation 613, source MN 602 may transmit a handover request message to target MN 605. For instance, source MN 602 may indicate target MN 605 to prepare a target SCG.

In operation 614, after target MN 605 receives the handover request message from source MN 602, target MN 605 transmits a request message (e.g., SgNB Addition Request message or SN Modification request message) to target SN 604 via Xn interface. In some embodiments, if the CHO Information SN Addition IE is included in the request message transmitted in operation 614, target SN 604 shall consider that the SN (S-NG-RAN node) Addition Preparation procedure has been triggered as a part of a CHO procedure. It may use the Source M-NG-RAN node ID IE and the Source M-NG-RAN node UE XnAP ID IE to identify other active S-NG-RAN node Addition Preparations related to UE 601. In some embodiments, if the Estimated Arrival Probability IE is contained in the CHO Information SN Addition IE included in the request message transmitted in operation 614, the S-NG-RAN node may use the information to allocate necessary resources for UE 601.

In operation 615, target SN 604 transmits an acknowledge message (e.g., SgNB Addition Request Acknowledge message or SgNB modification Request Acknowledge message) to target MN 605. RRC configuration(s) for a target SCG may be included in the acknowledge message.

In operation 616, after receiving the acknowledge message from target SN 604, target MN 605 transmits a handover request acknowledge message including CHO configuration(s) associated with the target SCG to source MN 602.

In operation 617, after receiving the handover request acknowledge message from target MN 605, source MN 602 transmits an RRC reconfiguration message including the CHO configuration(s) associated with the target SCG to UE 601.

In operation 618, after receiving the RRC reconfiguration message from source MN 602, UE 601 begins to evaluate CHO execution condition(s) for a target MCG when receiving the CHO configuration(s) in the RRC reconfiguration message. The target SCG included in the CHO configuration(s) may be the same as a source SCG of UE 601. UE 601 may be informed by the network that the configured target SCG included in the CHO configuration(s) is the same as the source SCG.

In operation 619, UE 601 initiates a SCG failure information procedure, to report information (e.g., information #1) related to a failure which occurs on the source SCG. In some embodiments, UE 601 may initiate the SCG failure information procedure when one of the following conditions is met:
(1) upon detecting an RLF for the source SCG;
(2) upon detecting a beam failure of the PSCell while the source SCG is deactivated;
(3) upon a reconfiguration with sync failure of the source SCG;
(4) upon a source SCG configuration failure; or
(5) upon an integrity check failure indication from source SCG lower layers concerning SRB3.

In operation 620, UE 601 may suspend a link between the source SCG and UE 601, when UE 601 initiates the SCG failure information procedure to report SCG failure related information (e.g., information #1) due to one of the following conditions:
(1) upon detecting an RLF for the source SCG;
(2) upon a reconfiguration with sync failure of the source SCG;
(3) upon a source SCG configuration failure; or
(4) upon an integrity check failure indication from source SCG lower layers concerning SRB3.

In operation 621, UE 601 considers CHO execution condition(s) as fulfilled, and UE 601 triggers a CHO procedure. There may be following options in different embodiments, i.e., Option 1, Option 2, and Option 3. (1) Option 1: UE 601 performs the CHO procedure towards the target MCG, i.e., a PCell. However, UE 601 will not perform an RA procedure to the target SCG (which is the same as the source SCG) i.e., a PSCell. After UE 601 successfully accesses the target PCell via the RA procedure, UE 601 may transmit an RRC reconfiguration complete message, which includes the information associated with a failure on the source SCG, to target MN 605. The information (e.g., information #2) may include at least one of as follows: a failure occurs on the source SCG; a failure occurs on the source SCG before performing the CHO procedure; or SCG failure information has been transmitted to source MN 602. In Option 1, RRC configuration(s) associated with the target SCG may be applied, and UE 601 may suspend a link between the target SCG and UE 601.
(2) Option 2: UE 601 performs the CHO procedure towards the target MCG, i.e., a PCell. UE 601 will not perform a RA procedure to the target SCG (which is the same as the source SCG) i.e., a PSCell. After UE 601 successfully accesses the PCell, SCG failure information procedure will be triggered. UE 601 transmits a SCG failure information message, which includes the information associated with a failure on the source SCG (e.g., information #2), to target MN 605. In Option 2, RRC configuration(s) associated with the target SCG may be applied, and UE 601 may suspend a link between the target SCG and UE 601. p1 (3) Option 3: UE 601 performs the CHO procedure towards the target MCG, i.e., a PCell, but RRC configuration(s) associated with the target SCG is not applied. UE 601 may inform target MN 605, e.g., via an RRC reconfiguration complete message or a SCG failure information message, that the RRC configuration(s) associated with the target SCG is not applied because that a failure happens on the source SCG. In Option 3, UE 601 may release the RRC configuration(s) associated with the target SCG.

In operation 622, target MN 605 may reconfigure a target SCG to UE 601.

FIG. 7 illustrates a flowchart of an exemplary procedure 700 of wireless communications in accordance with some embodiments of the present application. Operations 711 to 721B may be performed in the exemplary procedure 700. In a CHO procedure described in the embodiments of FIG. 7, a target SCG of a UE is the same as a source SCG of the UE.

In operation 711, UE 701 in an RRC connected state accesses its serving BS, i.e., source MN 702. For instance, DC (Dual Connectivity) may be configured for UE 701. UE 701 may report measurement result(s) to source MN 702.

In operation 712, based on the measurement result(s), source MN 702 may determine to switch UE 701 to target MN 705 via a CHO procedure.

In operation 713, source MN 702 may transmit a handover request message to target MN 705. For instance, source MN 702 may indicate target MN 705 to prepare a target SCG.

In operation 714, after target MN 705 receives the handover request message from source MN 702, target MN 705 transmits a request message (e.g., SgNB Addition Request message or SN Modification request message) to target SN 704 via Xn interface. In some embodiments, if the CHO Information SN Addition IE is included in the request message transmitted in operation 714, target SN 704 shall consider that the SN (S-NG-RAN node) Addition Preparation procedure has been triggered as a part of a CHO procedure. It may use the Source M-NG-RAN node ID IE and the Source M-NG-RAN node UE XnAP ID IE to identify other active S-NG-RAN node Addition Preparations related to UE 701. In some embodiments, if the Estimated Arrival Probability IE is contained in the CHO Information SN Addition IE included in the request message transmitted in operation 714, the S-NG-RAN node may use the information to allocate necessary resources for UE 701.

In operation 715, target SN 704 transmits an acknowledge message (e.g., SgNB Addition Request Acknowledge message or SgNB modification Request Acknowledge message) to target MN 705. RRC configuration(s) for a target SCG may be included in the acknowledge message.

In operation 716, after receiving the acknowledge message from target SN 704, target MN 705 transmits a handover request acknowledge message including CHO configuration(s) associated with the target SCG to source MN 702.

In operation 717, after receiving the handover request acknowledge message from target MN 705, source MN 702 transmits an RRC reconfiguration message including CHO configuration(s) associated with the target SCG to UE 701.

In operation 718, after UE 701 receives the RRC reconfiguration message from source MN 702, UE 701 begins to evaluate CHO execution condition(s) for a target MCG when receiving the CHO configuration(s) in the RRC reconfiguration message. The target SCG included in the CHO configuration(s) may be the same as a source SCG of UE 701. UE 701 may be informed by a network that the configured target SCG included in the CHO configuration(s) is the same as the source SCG.

In operation 719, UE 701 may initiate a SCG failure information procedure, to report information (e.g., information #1) related to a failure which occurs on the source SCG. UE 701 may initiate the SCG failure information procedure when one of the following conditions is met:
(1) upon detecting an RLF for the source SCG;
(2) upon detecting a beam failure of the PSCell while the source SCG is deactivated;
(3) upon a reconfiguration with sync failure of the source SCG;
(4) upon a source SCG configuration failure; or
(5) upon an integrity check failure indication from source SCG lower layers concerning SRB3.

In operation 720, UE 701 may suspend a link between the source SCG and UE 701, when UE 701 initiates the SCG failure information procedure to report SCG failure related information (e.g., information #1) due to one of the following conditions:
(1) upon detecting an RLF for the source SCG;
(2) upon a reconfiguration with sync failure of the source SCG;
(3) upon a source SCG configuration failure; or
(4) upon an integrity check failure indication from source SCG lower layers concerning SRB3.

After operation 720, there may be following two options in different embodiments, i.e., operation 721A or operation 721B.

In operation 721A (optional, which is marked as dotted lines), UE 701 continues to evaluate CHO execution condition(s). However, UE 701 does not perform the CHO procedure even the CHO execution condition(s) is met. UE 701 may further inform source MN 702 that the CHO execution condition(s) is met.

In operation 721B (optional, which is marked as dotted lines), UE 701 will stop evaluating CHO execution condition(s) for the target MCG when UE 701 suspends the link between the source SCG and UE 701.

Currently, there may be a case of a CHO procedure with different SNs in which a UE performs a CHO procedure from a source PCell with a source SCG in a source SN (e.g., SN #1) to a target PCell with a target SCG in a target SN (e.g., SN #2). There may be another case of a CHO procedure from single-connectivity to an (MR-)DC connection in which a UE performs a CHO procedure from a source PCell to a target PCell with a SCG in a SN. It is possible that a failure occurs during the CHO procedure. Thus, there is a need to solve an issue of how to avoid the failure occurs during the CHO procedure. The embodiments of FIG. 8 may solve the abovementioned issue.

FIG. 8 illustrates a flowchart of an exemplary procedure 800 of wireless communications in accordance with some embodiments of the present application. Operations 811 to 8203B may be performed in the exemplary procedure 800. In a CHO procedure described in the embodiments of FIG. 8, a target SCG of a UE may be the same as or different from a source SCG of the UE.

In operation 811, UE 801 in an RRC connected state accesses its serving BS, i.e., source MN 802. For instance, DC (Dual Connectivity) may be configured for UE 801. UE 801 may report measurement result(s) to source MN 802.

In operation 812, based on the measurement result(s), source MN 802 may determine to switch UE 801 to target MN 805 via a CHO procedure.

In operation 813, source MN 802 may transmit a handover request message to target MN 805. For instance, source MN 802 may indicate target MN 805 to prepare a target SCG.

In operation 814, after target MN 805 receives the handover request message from source MN 802, target MN 805 transmits a request message (e.g., SgNB Addition Request message or SN Modification request message) to target SN 804 via Xn interface. In some embodiments, if the CHO Information SN Addition IE is included in the request message transmitted in operation 814, target SN 804 shall consider that the SN (S-NG-RAN node) Addition Preparation procedure has been triggered as a part of a CHO procedure. It may use the Source M-NG-RAN node ID IE and the Source M-NG-RAN node UE XnAP ID IE to identify other active S-NG-RAN node Addition Preparations related to UE 801. In some embodiments, if the Estimated Arrival Probability IE is contained in the CHO Information SN Addition IE included in the request message transmitted in operation 814, the S-NG-RAN node may use the information to allocate necessary resources for UE 801.

In operation 815, target SN 804 transmits an acknowledge message (e.g., SgNB Addition Request Acknowledge message or SgNB modification Request Acknowledge message) to target MN 805. RRC configuration(s) associated with a target SCG may be included in the acknowledge message. In some cases, the target SCG may be the same as a source SCG of UE 801. In some cases, the target SCG may be different from the source SCG of UE 801.

In operation 816, after receiving the acknowledge message from target SN 804, target MN 805 transmits a handover request acknowledge message, which includes the CHO configuration(s) associated with the target SCG, to source MN 802. For instance, the CHO configuration(s) may include an RRC configuration for the target MCG and an RRC configuration for the target SCG. The RRC configuration for the target SCG (e.g., RRC delta configuration) may be updated based on an RRC configuration for the source SCG.

In operation 817, after receiving the handover request acknowledge message from target MN 805, source MN 802 transmits an RRC reconfiguration message including the CHO configuration(s) associated with the target SCG to UE 801.

In operation 818, after UE 801 receives the RRC reconfiguration message, UE 801 begins to evaluate CHO execution condition(s) for a target MCG when receiving the CHO configuration(s) associated with the target SCG.

In operation 819, source SN 803 configures to UE 801 for a change of a PSCell of the source SCG, without source MN 802 involvement. Or, in operation 819, RRC configuration(s) for the source SCG is reconfigured by source SN 803, i.e., an update of RRC configuration(s) for the source SCG, without source MN 802 involvement.

After operation 819, there may be following four options in different embodiments, i.e., Option a to Option d, in which at least one of operations 8201 to 8203B may be performed. Operations 8201 to 8203B are optional and marked as dotted lines.
Option a: In operation 8201, source SN 803 may indicate to source MN 802 in response to that the PSCell changes or configuration(s) associated with the source SCG is updated. For instance, source MN 802 may receive an indication from source SN 803, and the indication may indicate at least one of: a change of a PSCell of the source SCG; or an update of an RRC configuration for the source SCG
Option b: In operation 8202A, RRC configuration(s) associated with the target SCG will not be applied when UE 801 performs the CHO procedure to the target MCG. In operation 8202B, UE 801 reports the related information to target MN 805 (i.e., the target PCell) via an RRC reconfiguration complete message or a SCG failure information message. For instance, UE 801 reports information (e.g., information #3), which is associated with the change of the PSCell of the source SCG or the update of the RRC configuration for the source SCG, to target MN 805.
Option c: In operation 8202A, UE 801 performs the CHO procedure to the target MCG. During the CHO procedure, the RRC configuration(s) associated with the target SCG will be applied based on RRC configuration(s) associated with the latest source SCG (e.g., a new source SCG after the change of the PSCell of the source SCG) or based on the updated RRC configuration(s) associated with the source SCG after the update. In operation 8202B, UE 801 reports the related information to target MN 805 via an RRC reconfiguration complete message or a SCG failure information message after UE 801 successfully accesses the target PCell. For instance, UE 801 reports information (e.g., information #4), which is associated with the change of the PSCell of the source SCG or the update of the RRC configuration for the source SCG, to target MN 805.
Option d: In operation 8203A, UE 801 performs the CHO procedure to the target MCG. During the CHO procedure, the RRC configuration(s) associated with the target SCG will be applied based the RRC configuration(s) associated with the old source SCG. In other words, although there is the change of the PSCell of the source SCG or the update of the RRC configuration for the source SCG, the RRC configuration(s) associated with the target SCG is applied based on “the RRC configuration(s) associated with the original (old) source SCG before the change of the PSCell of the source SCG or the update of the RRC configuration for the source SCG”. In operation 8203B, UE 801 performs a RA procedure towards the target SCG. In some embodiments of Option (4), UE 801 may store the RRC configuration(s) associated with the original source SCG in response to: reception of the CHO configuration(s) associated with the target SCG, or the change of the PSCell of the source SCG, or the update of the RRC configuration for the source SCG.

Details described in all other embodiments of the present disclosure are applicable for the embodiments shown in any of FIGS. 6-8. It should be appreciated by persons skilled in the art that the sequence of the operations in any of exemplary procedures 600-800 in FIGS. 6-8 may be changed and some of the operations in any of exemplary procedures 600-800 in FIGS. 6-8 may be eliminated or modified, without departing from the spirit and scope of the disclosure.

FIG. 9 illustrates a block diagram of an exemplary apparatus 900 in accordance with some embodiments of the present disclosure. As shown in FIG. 9, the apparatus 900 may include at least one processor 906 and at least one transceiver 902 coupled to the processor 906.

Although in this figure, elements such as the at least one transceiver 902 and processor 906 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

In some embodiments of the present application, the apparatus 900 may be a UE, a target MN, a source MN, a target SN, or a source SN. The transceiver 902 and the processor 906 may interact with each other so as to perform the operations with respect to the UE, the target MN, the source MN, the target SN, or the source SN described above, for example, in any of FIGS. 1-8.

In some embodiments of the present application, the apparatus 900 may further include at least one non-transitory computer-readable medium. For example, in some embodiments of the present disclosure, the non-transitory computer-readable medium may have stored thereon computer-executable instructions to cause the processor 906 to implement the method with respect to the UEs as described above. For example, the computer-executable instructions, when executed, cause the processor 906 interacting with transceiver 902 to perform the operations with respect to the UE, the target MN, the source MN, the target SN, or the source SN described in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

What is claimed is:

1. A user equipment (UE) for wireless communication, comprising:
at least one memory; and
at least one processor coupled with the at least one memory and configured to cause the UE to:
receive a conditional handover (CHO) configuration associated with a target master cell group (MCG) and a target secondary cell group (SCG) wherein the CHO configuration includes a CHO execution condition for the target MCG, and wherein the target SCG is same as or different from a source SCG of the UE;
evaluate the CHO execution condition for the target MCG; and
perform a CHO procedure to the target MCG, in response to fulfillment of the CHO execution condition for the target MCG.

2. The UE of claim 1, wherein in response to the UE connected to a source MCG and in response to an occurrence of a failure on the source SCG, the at least one processor of the UE is configured to cause the UE to:
initiate a first SCG failure information procedure, to report first information associated with the failure on the source SCG to the source MCG; and
suspend a link between the source SCG and the UE.

24. The UE of claim 2, wherein, in response to the target SCG being the same as the source SCG, the at least one processor is configured to cause the UE to at least one of:
perform a random access (RA) procedure to the target MCG;
prohibit performing an RA procedure to the target SCG; or
transmit second information associated with a failure on the source SCG to the target MCG, in response to successfully completing an RA procedure to the target MCG.

4. The UE of claim 3, wherein the second information is included in a radio resource control (RRC) reconfiguration complete message.

5. The UE of claim 3, wherein the at least one processor is configured to cause the UE to initiate a second SCG failure information procedure, wherein the second information is included in a SCG failure information message, and wherein the SCG failure information message is transmitted to the target MCG.

6. The UE of any of claim 3, wherein the second information includes at least one of:
a first indication indicating that the failure occurs on the source SCG;
a second indication indicating that the failure occurs on the source SCG before performing the CHO procedure to the target MCG; or
a third indication indicating that the first information has been transmitted to the source MCG.

7. The UE of claim 3, wherein the CHO configuration includes an RRC configuration for the target SCG, and wherein the at least one processor is configured to cause the UE to at least one of:
apply the RRC configuration for the target SCG in response to performing the CHO procedure; or
continue to suspend the link between the source SCG and the UE.

8. The UE of claim 2, wherein the at least one processor is configured to cause the UE to consider the CHO execution condition for the target MCG as fulfilled while the UE is suspending the link between the source SCG and the UE.

9. The UE of claim 3, wherein the CHO configuration includes an RRC configuration for the target SCG, and wherein the at least one processor is configured to cause the UE to:
release the RRC configuration for the target SCG; and
transmit an RRC message including a fourth indication to the target MCG, wherein the fourth indication indicates at least one of: the RRC configuration for the target SCG is not applied; or the occurrence of the failure on the target SCG.

10. The UE of claim 1, wherein, in response to the target SCG being the same as or different from the source SCG, the CHO configuration includes an RRC configuration for the target MCG and an RRC configuration for the target SCG, and wherein the RRC configuration for the target SCG is updated based on an RRC configuration for the source SCG.

11. The UE of claim 10, wherein, in response to a change of a primary secondary cell group cell (PSCell) of the source SCG or an update of an RRC configuration for the source SCG, the at least one processor is configured to cause the UE to at least one of:
continue the CHO procedure to the target MCG;
prohibit applying the RRC configuration for the target SCG;
prohibit performing a random access (RA) procedure to the target SCG; or
transmit third information to the target MCG, wherein the third information is associated with the change of the PSCell of the source SCG or the update of the RRC configuration for the source SCG.

12. The UE of claim 11, wherein the third information is included in a radio resource control (RRC) reconfiguration complete message or a SCG failure information message.

13. The UE of claim 10, wherein, in response to a change of a primary secondary cell group cell (PSCell) of the source SCG or an update of an RRC configuration for the source SCG, the at least one processor is configured to cause the UE to:
perform the CHO procedure to the target MCG and the target SCG;
apply updated RRC configuration for the target SCG after the change of the PSCell of the source SCG or the update of the RRC configuration for the source SCG; and
transmit fourth information to the target MCG, wherein the fourth information is associated with the change of the PSCell of the source SCG or the update of the RRC configuration for the source SCG.

14. The UE of claim 11, wherein the at least one processor is configured to cause the UE to store the RRC configuration for the source SCG in response to reception of the CHO configuration or in response to the change of the PSCell of the source SCG or in response to the update of the RRC configuration for the source SCG.

15. A target master node (MN) for wireless communication, comprising:
at least one memory; and
at least one processor coupled with the at least one memory and configured to cause the target MN to:
receive a handover request message from a source MN;
transmit a handover request acknowledge message to the source MN, wherein the handover request acknowledge message includes a conditional handover (CHO) configuration associated with a target secondary cell group (SCG) of a user equipment (UE), and wherein the target SCG is same as or different from a source SCG of the UE; and
receive failure related information from the UE.

16. The UE of claim 14, wherein, in response to a change of a primary secondary cell group cell (PSCell) of the source SCG or an update of an RRC configuration for the source SCG, the at least one processor is configured to cause the UE to:
continue to perform the CHO procedure to the target MCG;
apply the RRC configuration for the target SCG during performing the CHO procedure to the target MCG; and
perform an RA procedure to the target SCG.

17. A processor for wireless communication, comprising:
at least one controller coupled with at least one memory and configured to cause the processor to:
receive a conditional handover (CHO) configuration associated with a target master cell group (MCG) and a target secondary cell group (SCG), wherein the CHO configuration includes a CHO execution condition for the target MCG, and wherein the target SCG is same as or different from a source SCG of a user equipment (UE);
evaluate the CHO execution condition for the target MCG; and
perform a CHO procedure to the target MCG, in response to fulfillment of the CHO execution condition for the target MCG.

18. The processor of claim 17, wherein in response to the UE connected to a source MCG and in response to an occurrence of a failure on the source SCG, the at least one controller is configured to cause the processor to:
initiate a first SCG failure information procedure, to report first information associated with the failure on the source SCG to the source MCG; and
suspend a link between the source SCG and the UE.

19. The processor of claim 18, wherein, in response to the target SCG being the same as the source SCG, the at least one controller is configured to cause the processor to at least one of:
perform a random access (RA) procedure to the target MCG;
prohibit performing an RA procedure to the target SCG; or
transmit second information associated with a failure on the source SCG to the target MCG, in response to successfully completing an RA procedure to the target MCG.

20. A source master node (MN) for wireless communication, comprising:
at least one memory; and
at least one processor coupled with the at least one memory and configured to cause the source MN to:
transmit a handover request message to a target MN; and
receive a handover request acknowledge message from the target MN, wherein the handover request acknowledge message includes a conditional handover (CHO) configuration associated with a target master cell group (MCG) and a target secondary cell group (SCG) of a user equipment (UE).
